(19) United States
(12) Patent Application Publication
(10) Pub. No.: US 2026/0367563 A1
(43) Pub. Date: Nov. 19, 2026

(54) IMAGE FORMING APPARATUS

(71) Applicants: Yusuke CHIBA, Kanagawa (JP); Shotaro HOSHI, Kanagawa (JP); Naoyuki OZAKI, Kanagawa (JP); Kazuya SAITO, Kanagawa (JP); Kenji YABE, Kanagawa (JP); Tatsumi YAMADA, Kanagawa (JP); Koichi YAMAWAKI, Tokyo (JP)

(72) Inventors: Yusuke CHIBA, Kanagawa (JP); Shotaro HOSHI, Kanagawa (JP); Naoyuki OZAKI, Kanagawa (JP); Kazuya SAITO, Kanagawa (JP); Kenji YABE, Kanagawa (JP); Tatsumi YAMADA, Kanagawa (JP); Koichi YAMAWAKI, Tokyo (JP)

(73) Assignee: ETRIA CO., LTD., Yokohama-shi (JP)

(21) Appl. No.: 19/656,542

(22) Filed: Apr. 23, 2026

(30) Foreign Application Priority Data
May 14, 2025 (JP) 2025-081417

(51) Int. Cl. G03G 15/00; G03G 15/02

(52) U.S. Cl. CPC G03G 15/553; G03G 15/0283; G03G 15/5062; G03G 15/80

(57) ABSTRACT

An image forming apparatus includes a latent image bearer, a charging unit bearer to uniformly charge a surface of the latent image bearer, detachably installed in the image forming apparatus, an exposure device to expose the latent image bearer, a developing device to develop a latent image on the latent image bearer with a developer into a toner image, a transfer device to transfer the toner image onto a sheet, and circuitry. The charging unit includes a charger disposed opposite the latent image bearer. The circuitry determines whether the charging unit being installed is a refurbished unit, forms a degradation level detection image to grasp a degradation level of the installed refurbished charging unit when detecting that the installed charging unit is the refurbished unit, and sets a remaining service life of the installed refurbished charging unit based on the degradation level detection image.

### CROSS-REFERENCE TO RELATED APPLICATIONS

This patent application is based on and claims priority pursuant to 35 U.S.C. § 119(a) to Japanese Patent Application No. 2025-081417, filed on May 14, 2025, in the Japan Patent Office, the entire disclosure of which is hereby incorporated by reference herein.

### BACKGROUND

### Technical Field

The present disclosure relates to an image forming apparatus.

### Related Art

An image forming apparatus includes a latent image bearer, a charging unit that includes a charger disposed opposite the surface of the latent image bearer, an exposure unit, a developing unit, and a transfer unit. The charger uniformly charges the surface of the latent image bearer. The exposure unit exposes the uniformly charged surface of the latent image bearer to form an electrostatic latent image. The developing unit develops the electrostatic latent image on the latent image bearer into a toner image with a developer. The transfer unit transfers the toner image from the latent image bearer onto a sheet, directly or indirectly via an intermediate transferor. An image forming apparatus including a control unit that determines the service life of a charging unit is proposed.

In such an image forming apparatus, a life counter counts up or down in proportion to the number of printed sheets or the driving time of a replaceable unit having a limited service life after detecting that the replaceable unit is new (unused). When a life counter value reaches a predetermined value, the control unit determines that the life of the unit has expired, and information for prompting replacement of the unit is displayed on a control panel.

### SUMMARY

The present disclosure described herein provides an image forming apparatus including a latent image bearer, a charging unit to uniformly charge a surface of the latent image bearer detachably installed in the image forming apparatus, an exposure device to expose the uniformly charged surface of the latent image bearer with light to form an electrostatic latent image, a developing device to develop the electrostatic latent image on the latent image bearer with a developer into a toner image, a transfer device to transfer the toner image from the latent image bearer onto a sheet directly or indirectly via an intermediate transferor, and circuitry. The charging unit includes a charger disposed opposite the surface of the latent image bearer. The circuitry determines whether the charging unit being installed is a refurbished unit, forms a degradation level detection image to grasp a degradation level of the installed refurbished charging unit when detecting that the installed charging unit is the refurbished unit, and sets a remaining service life of the installed refurbished charging unit based on the degradation level detection image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a front view of a color copier as an image forming apparatus and illustrates an overall configuration thereof;

FIG. 2 is a schematic view of one of four image forming units;

FIG. 3 is a functional block diagram of the color copier illustrated in FIG. 1;

FIG. 4 is a functional block diagram illustrating an example of an integrated circuit (IC) chip;

FIGS. 5A and 5B are diagrams illustrating a detection circuit board for detecting whether the unit is an unused, refurbished, or previously installed unit;

FIG. 6 is a diagram illustrating the arrangement of an IC chip and the detection circuit board illustrated in FIGS. 5A and 5B, in a charging unit;

FIG. 7 is a flowchart of an initial setup and adjustment operation after a process cartridge is replaced with a refurbished process cartridge including a refurbished charging unit;

FIG. 8 is a diagram illustrating an example of the relation between a developing potential and a toner adhesion amount;

FIG. 9 is a diagram illustrating an abnormal image due to the degradation of a charging unit;

FIG. 10 is a flowchart of a degradation level estimation process;

FIG. 11 is a diagram illustrating a background potential for normal printing and a background potential in the printing of a charging unit degradation detection image;

FIG. 12 is a graph illustrating the relation between a remaining life and {1/ (L*−L*′)}×Sa;

FIG. 13 is a diagram illustrating a life setting screen displayed on a display portion of a control panel;

FIG. 14 is a diagram illustrating another life setting screen displayed on a display portion of a control panel;

FIG. 15 is a diagram illustrating another life setting screen displayed on a display portion of a control panel; and

FIG. 16 is a diagram illustrating a data table indicating the relation between a remaining service life and a total rank, stored in a memory of a control unit.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

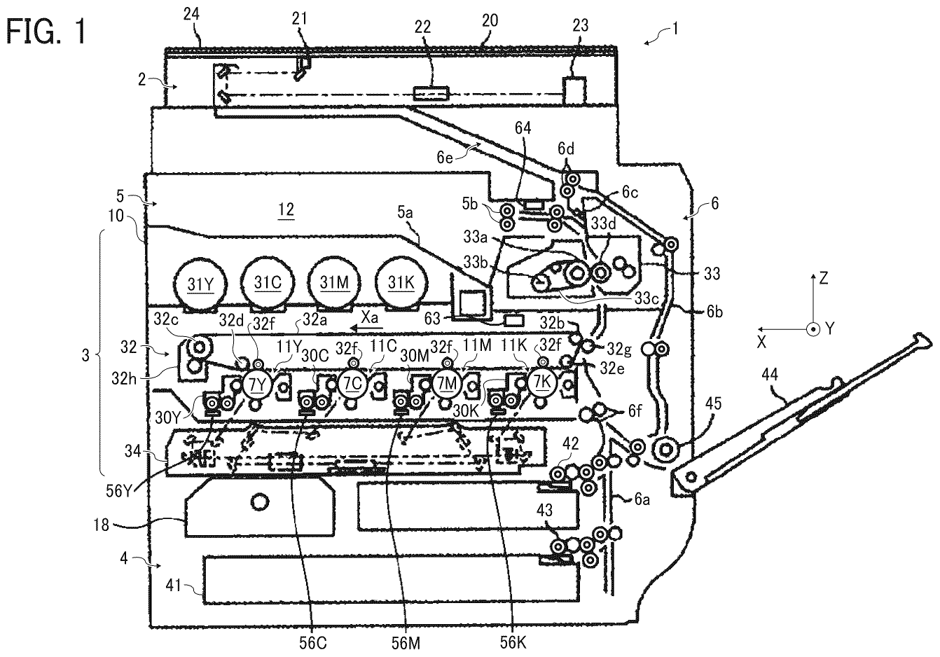

FIG. 1 is a front view of a color copier 1 as an image forming apparatus and illustrates an overall configuration thereof.

The color copier 1 illustrated in FIG. 1 is a color copier of the in-machine ejection type, in which sheets are ejected into an accessible internal space, and employs an electrophotographic process.

In the drawings, a Z direction is the vertical direction, a Y direction is the front-rear direction (also an axial direction) of the apparatus, and an X direction is the left-right direction of the apparatus.

The color copier 1 includes a substantially box-shaped apparatus body 10, which is the housing of the entire image forming apparatus, and an image reading device 2. The image reading device 2 is disposed above the apparatus body 10 and reads an image of a document.

The color copier 1 further includes an image forming device 3 inside the apparatus body 10. The image forming device 3 records (forms) an image on a sheet, such as a paper sheet, based on the image information read by the image reading device 2 or transmitted from an external device, such as a personal computer.

The color copier 1 further includes a sheet ejection space 12 between the image reading device 2 and the image forming device 3. A sheet on which an image is recorded is ejected into the sheet ejection space 12. In the lowermost portion of the apparatus body 10, a sheet feeder that feeds a sheet to a sheet conveyance path is disposed. The term “sheet” refers to a sheet-like recording medium including copy paper, a resin sheet for an overhead projector (OHP), thick paper, and a postcard. Above the image forming device 3, an in-machine ejection unit 5 that ejects a sheet on which an image is recorded to a sheet ejection space 12 is located. Between the sheet feeder and the in-machine ejection unit 5, a sheet conveyance path 6 is located.

The image reading device 2 includes an exposure glass 20 as a platen on which a document is placed. The image reading device 2 further includes a light source 21, an imaging lens 22, and an image sensor 23, such as a charge-coupled device (CCD), which serves as a reader to read the document image. The light source 21 is disposed directly below the exposure glass 20 and irradiates the document with light while moving. The imaging lens 22 forms an image of the light reflected from the document. The image sensor 23 is disposed at the position where the reflected light is imaged. The image reading device 2 further includes multiple mirrors that guide light reflected from the document to the imaging lens 22 while reflecting the light.

Above the image reading device 2, a pressure plate 24 is disposed to press the document on the exposure glass 20. Instead of the pressure plate 24, an automatic document feeder (ADF) that automatically feeds a document to the exposure glass 20 may be used.

The image forming device 3 includes four image forming units 11Y, 11C, 11M, and 11K corresponding to toners of four colors, i.e., yellow, cyan, magenta, and black. Yellow, cyan, and magenta are three primary colors of colorants. The image forming units 11Y, 11C, 11M, and 11K may be collectively referred to as the “image forming units 11” when not distinguished. The image forming device 3 is disposed below the four image forming units 11Y, 11C, 11M, and 11K, and includes a writing unit 34 that is an exposure device to write latent images on the photoconductor drums described later, of the image forming units 11Y, 11C, 11M, and 11K. The image forming device 3 includes four toner bottles 31Y, 31C, 31M, and 31K that store new toners of colors corresponding to the image forming units 11Y, 11C, 11M, and 11K.

The image forming device 3 further includes a transfer unit 32 (transfer device) and a fixing unit 33. The transfer unit 32 temporarily transfers the toner images formed by the image forming units 11Y, 11C, 11M, and 11K onto an intermediate transferor and further transfers the toner images onto a sheet. The fixing unit 33 fixes the toner images on the sheet.

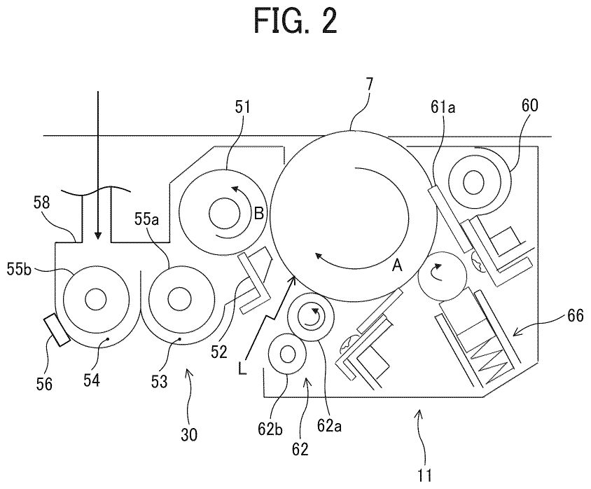

The image forming units 11Y, 11C, 11M, and 11K are arranged in the order of yellow, cyan, magenta, and black from the upstream side in the moving direction, indicated by arrow Xa in the figure, of the outer peripheral face of an intermediate transfer belt 32a as the intermediate transferor. The image forming units 11Y, 11C, 11M, and 11K include photoconductor drums 7Y, 7C, 7M, and 7K, respectively. The photoconductor drums 7Y, 7C, 7M, and 7K (may be collectively referred to as the “photoconductor drums 7”) are latent image bearers and rotate clockwise in a front view. Each image forming unit 11 further includes a charging unit 62, corresponding one of developing units 30Y, 30C, 30M, and 30K (see FIG. 2), and a photoconductor cleaning blade 61a (see FIG. 2) around the photoconductor drum. The developing units 30Y, 30C, 30M, and 30K may be collectively referred to as the “developing units 30.”

The charging unit 62 uniformly charges the outer circumferential surface of corresponding one of the photoconductor drums 7Y, 7C, 7M, and 7K. The developing units 30Y, 30C, 30M, and 30K (developing devices) visualize electrostatic latent images formed on the photoconductor drums 7Y, 7C, 7M, and 7K by the writing unit 34 as the exposure unit described later, into monochromatic toner images with corresponding color toner. The photoconductor cleaning blade 61a collects residual toner remaining on the outer circumferential surface of the photoconductor drum 7 after the transfer, and cleans the photoconductor drum 7.

The writing unit 34 includes a polygon mirror and an fθ lens. The writing unit 34 emits laser light from a laser emitting device based on image information received from, for example, the image reading device 2, a personal computer, or an external scanner, and scans the photoconductor drum 7. Then, the writing unit 34 selectively exposes the uniformly charged outer circumferential surfaces of the photoconductor drums 7Y, 7C, 7M, and 7K to light to reduce the surface potentials on the irradiated portions, thereby forming electrostatic latent images on the photoconductor drums 7Y, 7C, 7M, and 7K.

The toner bottles 31Y, 31C, 31M, and 31K are respectively filled with fresh toner of yellow, cyan, magenta, and black. The toner in the toner bottles 31Y, 31C, 31M, and 31K is supplied through supply paths to the respective developing units 30Y, 30C, 30M, and 30K of the image forming units 11Y, 11C, 11M, and 11K.

The transfer unit 32 serving as a transfer device includes an intermediate transfer belt 32a serving as the intermediate transferor, which is a multilayer endless belt formed of elastic resin. The intermediate transfer belt 32a is supported and tensioned around multiple rollers. The term “tensioned” refers to a state in which the belt is stretched under tensile force. In particular, the intermediate transfer belt 32a is supported and tensioned by four support rollers 32b, 32c, 32d, and 32e, four primary transfer rollers 32f as transfer members, and a secondary transfer roller 32g as another transfer member.

The support roller 32b is a drive roller coupled to a driver. The support roller 32b drives the intermediate transfer belt 32a to rotate in the direction of arrow Xa in the figure. At the position opposite the support roller (drive roller) 32b with the intermediate transfer belt 32a interposed therebetween, a secondary transfer roller 32g is disposed or positioned. Near the support roller 32c, a belt cleaning unit 32h is disposed. The belt cleaning unit 32h cleans the outer circumferential face of the intermediate transfer belt 32a by scraping off residual toner therefrom.

The transfer unit 32 further includes an optical sensor unit 63. The optical sensor unit 63 includes multiple optical sensors as an adhesion amount detecting sensor, and the multiple optical sensors face the surface of the intermediate transfer belt 32a at predetermined intervals in the widthwise direction of the belt. When an image adjustment control described later is performed, the optical sensor of the optical sensor unit 63 detects the amount (mg/cm²) of toner adhering to each toner patch of a gradation pattern formed on the intermediate transfer belt 32a. Specifically, a photodiode as a light-receiving element detects the specularly reflected light and diffusely reflected light of light emitted from the light-emitting element of the optical sensor toward the intermediate transfer belt 32a, thereby detecting the amount of toner adhering. The image adjustment control is performed periodically, or when the transfer unit 32 or a process cartridge (or a photoconductor unit 60Y, 60M, 60C, or 60K) is replaced.

Each primary transfer roller 32f is disposed at a position slightly downstream, in the moving direction of the intermediate transfer belt 32a, from the geometrically closest opposing position where the corresponding one of the photoconductor drums 7Y, 7C, 7M, and 7K faces and make contact the intermediate transfer belt 32a at the shortest center-to-center distance, in view of preventing image degradation due to gap discharge. The term “gap discharge” refers to electrical discharge occurring across an air gap between opposing members.

Each primary transfer roller 32f serves as a transfer bias applying member that applies a contact-type transfer bias (transfer voltage). To be more specific, each primary transfer roller 32f is coupled to a bias power source, and applies a primary transfer bias (applies a voltage, the same applies to the following description) from the back surface (inner circumferential surface) of the intermediate transfer belt 32a.

The secondary transfer roller 32g is biased by a biasing member to be pressed against the intermediate transfer belt 32a at the outer periphery of the support roller (drive roller) 32b. The contact portion between the secondary transfer roller 32g and the support roller (drive roller) 32b is referred to as a secondary transfer nip. The support roller (drive roller) 32b is a transfer bias applying member that is coupled to a bias power source and applies a contact-type transfer bias. The secondary transfer roller 32g may serve as the transfer bias applying member. In this case, a transfer bias having the opposite polarity to the polarity of the toner image to be transferred is applied.

The fixing unit 33 includes a fixing belt 33c, which is an endless belt stretched around a fixing roller 33a and a heating roller 33b, and a pressure roller 33d as a pressure member. The pressure roller 33d is pressed against the fixing belt 33c (i.e., brought into pressure contact with the fixing belt 33c). The contact portion between the pressure roller 33d and the fixing belt 33c is referred to as a fixing nip. In the fixing nip, heat and pressure are applied to the sheet conveyed through the sheet conveyance path 6 described later, and the toner image transferred in the secondary transfer nip of the transfer unit 32 described above is fused and fixed on the sheet.

The sheet feeder includes sheet feeding trays 40 and 41 that store different size sheets, and sheet feeding rollers 42 and 43 that press against the stored sheets from above with a predetermined pressure. The sheet feeding trays 40 and 41 can be pulled out from the apparatus body 10. The sheet feeder feeds the sheets stored in the sheet feeding trays 40 and 41 to the sheet conveyance path 6 described later by the sheet feeding rollers 42 and 43 according to a control signal from a controller.

The sheet feeder includes a bypass feeding tray 44 to accommodate a sheet of any size within a size range supported by the color copier 1, and a sheet feeding roller 45 that feeds the sheet. The sheet feeder feeds a sheet placed on a bypass feeding tray 44 to a sheet conveyance path 6 described later by rotating a sheet feeding roller 45.

The in-machine ejection unit 5 includes an output tray 5a formed by a slope of the apparatus body 10 below the sheet ejection space 12. The sheet ejection space 12 is located between the toner bottles 31Y, 31C, 31M, and 31K and the image reading device 2. The in-machine ejection unit 5 further includes an ejection roller pair 5b that ejects the sheet passing through the fixing unit 33 to the output tray 5a through the sheet conveyance path 6 described later. As described above, the color copier 1 is of an internal sheet ejection type and has the function of stacking the sheet ejected by the ejection roller pair 5b on the output tray 5a.

The sheet conveyance path 6 includes a normal conveyance path 6a of vertical conveyance (vertical path) for conveying a sheet from a sheet feeder in a lower part of the apparatus body 10 to the in-machine ejection unit 5 in an upper part of the apparatus body 10 from the bottom. The sheet conveyance path 6 further includes a reverse conveyance path 6b for reversing a sheet for duplex printing. These conveyance paths can be switched by a switching claw 6c, and the sheet is guided to the reverse conveyance path 6b by the switching claw 6c. The sheet guided to the reverse conveyance path 6b is conveyed to an upper portion 6e of the reverse conveyance path 6b by a reverse conveyance roller pair 6d, and then reversed in a switchback manner as the reverse conveyance roller pair 6d rotate in reverse. Then, the sheet is conveyed to the normal conveyance path 6a in front of a registration roller pair 6f described later.

The normal conveyance path 6a and the reverse conveyance path 6b are provided with multiple conveyance roller pairs at intervals corresponding to the minimum sheet size. As the conveyance roller pairs rotate with the sheet nipped therein, the sheet is conveyed. The normal conveyance path 6a is further provided with the registration roller pair 6f disposed below the secondary transfer nip. The registration roller pair 6f adjusts the timing of conveying the sheet to the secondary transfer nip based on a command from the controller.

On the left of the sheet feeding tray 40 in FIG. 1, a waste-toner container 18 is disposed. The waste-toner container 18 accommodates waste toner removed by the respective photoconductor cleaning blades 61a of the image forming units 11Y, 11C, 11M, and 11K and waste toner removed by the belt cleaning unit 32h of the transfer unit 32.

FIG. 2 is a diagram illustrating a schematic configuration of one of the four image forming units 11.

The four image forming units 11 have substantially the same structure except that the colors of the toners used are different. In the drawings, suffixes Y, M, C, and K, which denote the colors of the toner, are omitted from the reference signs of components of the units such as the image forming units 11 and the developing units 30.

The image forming unit 11 is a detachably installable process cartridge (detachable unit) and includes, as integral components, the photoconductor drum 7 serving as a latent image bearer, the photoconductor unit 60, and a developing unit 30, which are collectively installed in and detached from the apparatus body 10. The photoconductor unit 60 collectively supports the components around the photoconductor drum 7, such as the charging unit 62, the photoconductor cleaning blade 61a, a lubricant application unit 66, and a static eliminator. The photoconductor unit 60 and the developing unit 30 may be independently installable and detachable from the apparatus body 10. The charging unit 62 may be independently installable to and detachable from the apparatus body 10.

The image forming unit 11 performs an image forming process (a charging process, an exposure process, a developing process, a transfer process, and a cleaning process) on the photoconductor drum 7 to form an image of the corresponding color on the photoconductor drum 7.

The photoconductor drum 7 rotates in the direction indicated by arrow A in FIG. 2, driven by a drive motor. The charging unit 62 includes a charging roller 62a serving as a charger, which is applied with a charging bias, so that the surface of the photoconductor drum 7 is uniformly charged (charging process). The surface of the photoconductor drum 7 then reaches an irradiation position of a laser beam L emitted from the writing unit 34 serving as an exposure device. The writing unit 34 forms an electrostatic latent image corresponding to the toner color by exposure scanning at this position (exposure process).

Then, the surface of the photoconductor drum 7 reaches a position opposite the developing unit 30. The developing unit 30 develops the electrostatic latent image at this position to form a toner image of the corresponding color (developing process). When the surface of the photoconductor drum 7 reaches a primary transfer position at which the photoconductor drum 7 faces the primary transfer roller 32f via the intermediate transfer belt 32a, the toner image on the photoconductor drum 7 is transferred onto the intermediate transfer belt 32a (primary transfer process). The respective toner images formed on the photoconductor drums 7Y, 7M, 7C, and 7K (see FIG. 1) are transferred to and superimposed on the intermediate transfer belt 32a. Thus, a multicolor toner image is formed on the intermediate transfer belt 32a. The photoconductor cleaning blade 61a collects residual toner remaining on the outer circumferential surface of the photoconductor drum 7 after the transfer.

The configuration and operation of the developing unit 30 will be described below in more detail.

The developing unit 30 includes a developing case 58. The developing case 58 contains a developing roller 51 disposed opposite the photoconductor drum 7, a doctor blade 52 disposed opposite the developing roller 51, and first and second conveying screws 55a and 55b disposed in first and second developer containing compartments 53 and 54, respectively. To the developing case 58, a toner concentration sensor 56 (56Y, 56M, 56C or 56K) that detects the toner concentration in the developer in the first developer containing compartment 53 is attached.

The developing roller 51 is disposed opposite the photoconductor drum 7 with a small gap, thereby forming a developing range. The developing roller 51 includes a stationary magnet having multiple magnetic poles fixed therein, and a sleeve that rotates around the magnet. The first and second developer containing compartments 53 and 54 contain a two-component developer including carrier and toner. The second developer containing compartment 54 includes a toner supply inlet 57 formed in an upper portion thereof.

The sleeve of the developing roller 51 rotates in the direction indicated by arrow B in FIG. 2. The developer is borne on the developing roller 51 by a magnetic field generated by the magnet. As the sleeve rotates, the developer moves along the circumference of the developing roller 51. The percentage (concentration) of toner in the developer (ratio of toner to carrier) in the developing unit 30 is adjusted within a specified range. In accordance with the consumption of the toner in the developing unit 30, the toner is supplied from the toner bottle 31 via a toner supply device into the developing case 58.

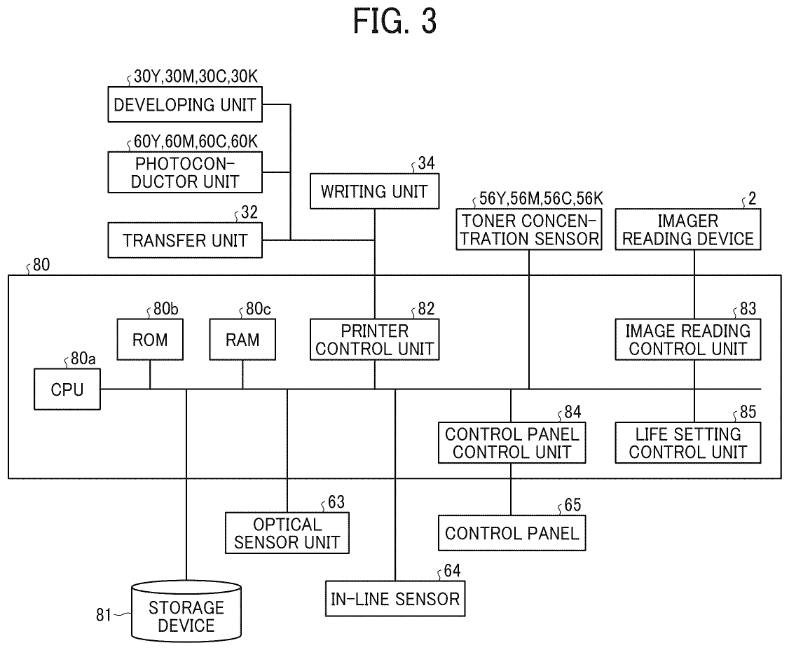

FIG. 3 is a functional block diagram of the color copier 1.

A controller 80 includes a CPU 80a, a read-only memory (ROM) 80b, a RAM 80c, a printer control unit 82, an image reading control unit 83, a control panel control unit 84, and a life setting control unit 85, and these units are connected to each other via a bus.

The CPU 80a starts an operating system (OS) using a boot program stored in the ROM 80b. The CPU 80a executes a control program stored in a memory (e.g., a storage device 81 or the ROM 80b) under the control of the OS, to control the entire operation of the color copier 1. For example, the CPU 80a executes a predetermined control program to control the toner supply and the image density adjustment described above.

The RAM 80c provides memory resources for the CPU 80a, including a main memory area and a work area. The storage device 81 (memory) is a readable and writable non-volatile storage device, such as a hard disk drive (HDD). The storage device 81 stores various kinds of data, such as programs to control the entire operation of the color copier 1, various types of application programs, data used to manage consumable items, and moving images presenting a series of work for solving maintenance events.

The printer control unit 82 functions as an interface for the CPU 80a to control the hardware elements related to the printer, such as the developing unit 30, the photoconductor unit 60, the sheet feeder 4, the writing unit 34, and the fixing unit 33. The image reading control unit 83 functions as an interface for the CPU 80a to control the image reading device 2.

The control panel 65 includes an input device, such as a touch screen or a hard key for receiving operations and instructions from a user, and a display device such as a liquid crystal display (LCD) or a cathode ray tube (CRT). The control panel control unit 84 functions as an interface for the CPU 80a to control the control panel 65.

As illustrated in FIG. 1, the in-line sensor 64 is disposed between the switching claw 6c, which switches the destination of the sheet that has passed through the fixing unit 33, and the ejection roller pair 5b, and reads an image formed on the sheet as described later.

The life setting control unit 85 controls a series of operations performed by the CPU 80a executing a predetermined program to set the life of the installed charging unit 62 that is a refurbished unit, which will be described later. Specifically, the life setting control unit 85 determines whether the charging unit 62 is replaced, and whether the installed charging unit 62 is an unused unit or a refurbished unit.

When the charging unit 62 installed in the apparatus body 10 is a refurbished unit, the degradation level of the charging unit 62 is estimated. Further, the life setting is performed for the refurbished charging unit 62 based on the estimated degradation level of the charging unit 62.

The CPU 80a executes a predetermined program to perform service life determination on the charging unit 62. In detail, the CPU 80a counts the number of printed sheets from the time point when the charging unit 62 is replaced, and, when the cumulative number of printed sheets reaches the set end-of-life print count, the service life of the charging unit 62 is determined to have expired. Then, the control panel 65 displays an instruction to replace the charging unit 62 determined to have reached the end of its life. Further, when the cumulative number of printed sheets approaches the set end-of-life print count, the CPU 80a displays, on the control panel 65, a message indicating that the service life of the charging unit 62 is approaching the end, and prompts the user to contact the service center to arrange a replacement charging unit 62. Alternatively, the CPU 80a notifies the service center that there is a charging unit 62 whose life is close to the end via the Internet.

Specifically, the CPU 80a calculates the average number of printed sheets per day from the daily printing activity, and calculates the remaining service life (in days) until the charging unit 62 reaches the end of its life from the calculated average number of printed sheets per day and the difference between the set end-of-life print count and the cumulative number of printed sheets after the charging unit 62 is replaced. When the remaining service life (in days) is less than the threshold, the CPU 80a determines that the charging unit 62 is close to the end of its life. The CPU 80a then displays an indication that the charging unit 62 is close to the end of its life on the control panel 65, or notifies the service center that the charging unit 62 is close to the end of its life.

In the configuration where the charging unit 62 is replaced together with the process cartridge (or the photoconductor unit 60) that is the detachable unit, when it is determined that the charging unit 62 is close to the end of its life, the control panel 65 displays a message indicating that the process cartridge or the photoconductor unit 60 is close to the end of its life. Further, the service center is notified that the life of the process cartridge or the photoconductor unit 60 is close to the end.

As initiatives such as the Sustainable Development Goals (SDGs) have become more widely adopted, the reuse and recycling of components are now desired in the field of electrophotography. In the machines returned from the market on a daily basis for various reasons, the charging unit 62 is sometimes found to have remaining service life. Depending on the reason for return, the charging unit 62 is usable from the hardware viewpoint unless the reason for return is a failure or the life of the charging unit 62. When the returned charging unit 62 whose service life remains is reused, it is desirable to use reusable components, such as the charging roller 62a, as they are, and clean the interior of the charging unit 62 before reuse, thereby lowering the cost of the refurbished charging unit 62.

The toner and the lubricant that are not removed by the photoconductor cleaning blade 61a gradually solidifies on the charging unit 62 due to use over time, and the surface of the charging roller 62a is gradually contaminated. As illustrated in FIG. 2, the charging unit 62 of the present embodiment includes a charging roller cleaner 62b that cleans the surface of the charging roller 62a. However, the charging roller cleaner 62b deteriorates with time, and the cleaning performance of the charging roller cleaner 62b is lowered, so that the surface of the charging roller 62a is gradually contaminated. The dirt adhering to the charging roller 62a changes the electric resistance value of the charging roller 62a, and the charging roller 62a deteriorates. When the charging roller 62a deteriorates, an abnormal image (substandard image) due to a defective charging, such as insufficient charging, occurs when the surface of the photoconductor drum 7 is charged. Then, the charging unit 62 reaches the end of its life. Specifically, in a portion of the surface of the photoconductor drum 7 where insufficient charging occurs, a background potential decreases, causing toner to adhere to that portion and resulting in a streaked image as an abnormal image. The background potential is the difference between the surface potential of an unexposed portion of the photoconductor drum 7 and the surface potential of the developing roller 51.

As described above, when the charging roller 62a is reused, the contaminant deposited on the charging roller 62a is removed, but the contaminant on the charging roller 62a may not be completely removed. In particular, in a configuration in which the charging unit 62 is replaced together with the process cartridge (or the photoconductor unit 60), when only the interior is cleaned by, for example, air blowing without disassembling the charging unit 62 in order to reduce recycling costs, the contamination is likely to remain on the surface of the charging roller 62a.

The service life of the refurbished charging unit 62 differs depending on the level of contamination on the surface of the charging roller 62a. In the case of an unused unit, the control is performed on the assumption that the product has a service life of 100%, but a refurbished unit needs to be controlled with a service life corresponding to the charging unit 62. The refurbished unit is also referred to as a reused unit, a used product, or a recycled product.

As described above, it is desirable that the service life is determined based on the cumulative number of printed sheets after the charging unit 62 is replaced, and the user or the serviceperson receives a notification the at the stage where the service life is approaching the end. To determine the service life, it is desirable to grasp the service life of the charging unit 62 with high accuracy in advance.

In view of this, when the charging unit 62 is replaced with a refurbished charging unit 62 (when the charging unit 62 is installed in the color copier for the first time), the degradation level of the installed refurbished charging unit 62 is estimated. Then, the end-of-life print count is determined based on the estimated degradation level.

Detection of replacement of the charging unit 62 and detection of whether the replaced unit is a refurbished unit or an unused unit will be described below.

The detection of replacement and the detection of whether the charging unit 62 is refurbished or unused are performed based on information stored in an IC chip, which is a non-volatile memory, in the charging unit 62. Specifically, information indicating one of “unused unit,” “refurbished unit,” and “previously installed unit” is stored in the IC chip.

In a configuration in which the charging unit 62 is installed in the process cartridge (or the photoconductor unit 60) and the charging unit 62 is replaced together with the process cartridge (or the photoconductor unit 60), the IC chip may be included in the casing of the process cartridge (or the photoconductor unit 60).

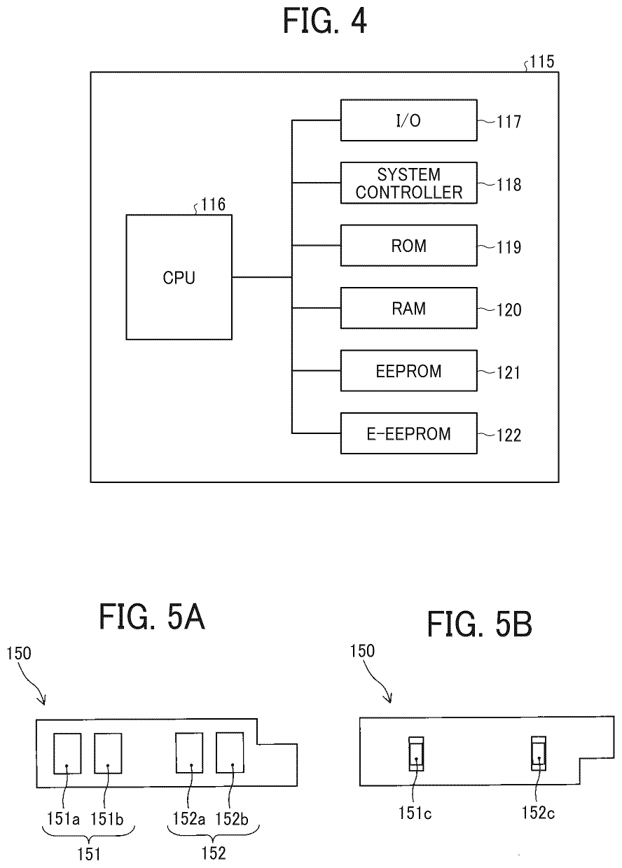

FIG. 4 is a block diagram illustrating a functional configuration of an IC chip 115.

A CPU 116 of the IC chip 115 communicates with the CPU 80a of the apparatus body 10 of the color copier 1 via an input/output (I/O) port 117, using an International Organization for Standardization (ISO) 7816-compliant communication protocol.

The CPU 116 communicates with the CPU 80a of the apparatus body 10 by a program stored in a ROM 119, and reads and writes data from and to an electrically erasable programmable read-only memory (EEPROM) 121, which is a non-volatile memory, according to a command from the CPU 80a of the apparatus body 10. The I/O port 117 is a communication interface circuit compliant with ISO 7816-3. A system controller 118 is a circuit for controlling the inside of the IC chip 115. The ROM 119 is a program memory, and a RAM 120 is a work memory for executing a program. The EEPROM 121 serving as a memory is a non-volatile memory. An electrically erasable programmable read-only memory (E-EEPROM) 122 is a memory that stores a dedicated instruction for writing to the EEPROM 121.

Information indicating one of “unused unit,” “refurbished unit,” and “previously installed unit” is stored in a predetermined memory address of the EEPROM 121. This information serves as information indicating whether the charging unit 62 is a refurbished unit. For example, when the charging unit 62 is an “unused unit” that has never been installed in the apparatus body 10 after shipment, “01 h” is stored in the memory address. By contrast, for a “refurbished unit” which is returned to the manufacturer after being used in another copier, maintained, and shipped again, “02 h” is stored in the memory address.

The information indicating “refurbished unit” is rewritten in the EEPROM 121 in maintenance performed at a recycling plant for reshipping the unit as a refurbished unit.

For a “previously installed unit” that has been once installed in a color copier 1, information indicating “00 h” is stored in the memory address. Rewriting of the information in the EEPROM 121 to the information indicating “previously installed unit” is performed at the end of an initial setup and adjustment operation described later, performed after replacement of the charging unit 62.

For example, when the CPU 80a of the apparatus body 10 detects that the opening of the apparatus body 10 to which the charging unit 62 is detachably installed is opened and closed, the CPU 80a of the apparatus body 10 transmits the following command to the CPU 116 of the IC chip 115. Specifically, the CPU 80a transmits a command to read the information at the memory address in the EEPROM 121 where the information indicating one of the “unused unit,” the “refurbished unit,” and the “previously installed unit” is stored.

The CPU 116 of the IC chip 115 reads out the information at the memory address of the EEPROM 121 based on the command, and transmits the read information to the CPU 80a of the apparatus body 10 via the I/O port 117. The CPU 80a of the apparatus body 10 detects whether the installed charging unit 62 is an unused refurbished, or previously installed unit based on the information at the memory address, received from the IC chip 115. When the received information at the memory address is “01 h (unused unit)” or “02 h (refurbished unit),” the CPU 80a determines that the charging unit 62 has been replaced and performs the initial setup and adjustment operation described later.

Further, whether the charging unit 62 installed in the apparatus body 10 is an unused, refurbished, or previously installed unit may be detected by using a detection circuit board for detecting whether the unit is an unused, refurbished, or previously installed unit.

FIGS. 5A and 5B are diagrams illustrating a detection circuit board 150 for detecting whether the unit is an unused, refurbished, or previously installed unit. FIG. 5A illustrates the front surface of the detection circuit board 150, and FIG. 5B illustrates the back surface of the detection circuit board 150.

The detection circuit board 150 includes a first circuit portion 151 as a first electric circuit for detecting whether the unit is an unused unit, and a second circuit portion 152 as a second electric circuit for detecting whether the unit is a refurbished unit. The first circuit portion 151 includes electrodes 151a and 151b that contact the connection terminals of the apparatus body 10, and a fuse attachment portion 151c to which a fuse is attached. The second circuit portion 152 includes electrodes 152a and 152b that contact the connection terminals of the apparatus body 10, and a fuse attachment portion 152c to which a fuse is attached. The electrodes 151a, 151b, 152a, and 152b of the first and second circuit portions 151 and 152 are disposed on the front surface of the detection circuit board 150 as illustrated in FIG. 5A, and the fuse attachment portions 151c and 152c are disposed on the back surface of the detection circuit board 150 as illustrated in FIG. 5B.

When the charging unit 62 is an unused unit, a fuse capable of being energized is attached to the fuse attachment portion 151c of the first circuit portion 151. When the charging unit 62 is a refurbished unit, a fuse capable of being energized is attached to the fuse attachment portion 152c of the second circuit portion 152. In maintenance performed at a recycling plant for reshipping the unit as a refurbished unit, the detection circuit board having a fuse attached to the fuse attachment portion 151c of the first circuit portion 151 is replaced with a detection circuit board having a fuse attached to the fuse attachment portion 152c of the second circuit portion 152.

When the charging unit 62 is installed in the apparatus body 10 of the color copier 1, the connection terminals on the apparatus body 10 contact the electrodes 151a, 151b, 152a, and 152b, and voltage is applicable to the first circuit portion 151 and the second circuit portion 152.

The CPU 80a of the apparatus body 10 applies voltages to the first circuit portion 151 and the second circuit portion 152 in response to the detection of the closing of the opening of the apparatus body 10 to which the charging unit 62 is installed and uninstalled.

When the charging unit 62 installed in the apparatus body 10 is an unused unit, the first circuit portion 151 is energized because the fuse capable of energizing is attached thereto. By contrast, the second circuit portion 152 is not energized because no fuse is attached thereto. As described above, when the energization of only the first circuit portion 151 is confirmed, the installation of an unused charging unit 62 in the apparatus body 10 is detected. After the “unused unit” is detected, the fuse is blown to be insulated. Specifically, after the completion of the initial setup and adjustment operation for the unused charging unit 62 described later, the fuse is blown. Then, the electrical state is switched from the state capable of being energized, indicating that the charging unit 62 is unused to the insulated state indicating that the use of the unit has been started.

When the charging unit 62 installed in the apparatus body 10 is a refurbished unit, the first circuit portion 151 is not energized because no fuse is attached thereto, and the second circuit portion 152 is energized because a fuse capable of being energized is attached thereto. In this way, when the energization of only the second circuit portion 152 is confirmed, the installation of a refurbished charging unit 62 in the apparatus body 10 is detected. After the “refurbished unit” is detected, the fuse is blown after the completion of the initial setup and adjustment operation, and the electrical state is switched from the state capable of being energized, indicating that the article is a refurbished unit to the insulated state indicating that the use of the unit has been started, as in the case of the “unused unit” described above.

By contrast, when the fuse of the first circuit portion 151 or the second circuit portion 152 is in an insulated state after the installation, neither the first circuit portion 151 nor the second circuit portion 152 is energized. Accordingly, when the energization of both the first circuit portion 151 and the second circuit portion 152 is not confirmed, the installation of a previously installed charging unit 62 is detected.

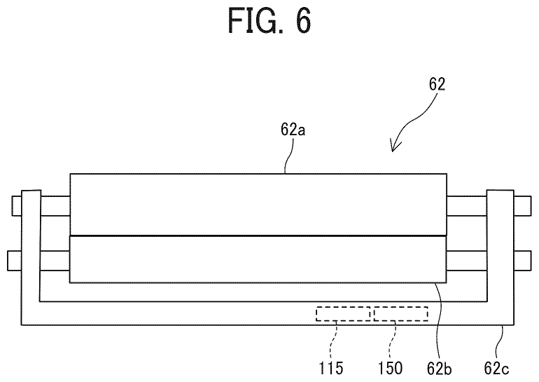

For example, as illustrated in FIG. 6, the IC chip 115 and the detection circuit board 150 are disposed on a casing 62c of the charging unit 62. In a configuration where the charging unit 62 is replaced together with the process cartridge or the photoconductor unit 60 as a whole, the IC chip 115 and the detection circuit board 150 are disposed on the outer circumferential surface of the casing of the process cartridge or the photoconductor unit 60, for example.

The initial setup and adjustment operation is described below. This operation is performed when an unused or refurbished charging unit 62 is installed in the case where the charging unit 62 is replaced together with the process cartridge.

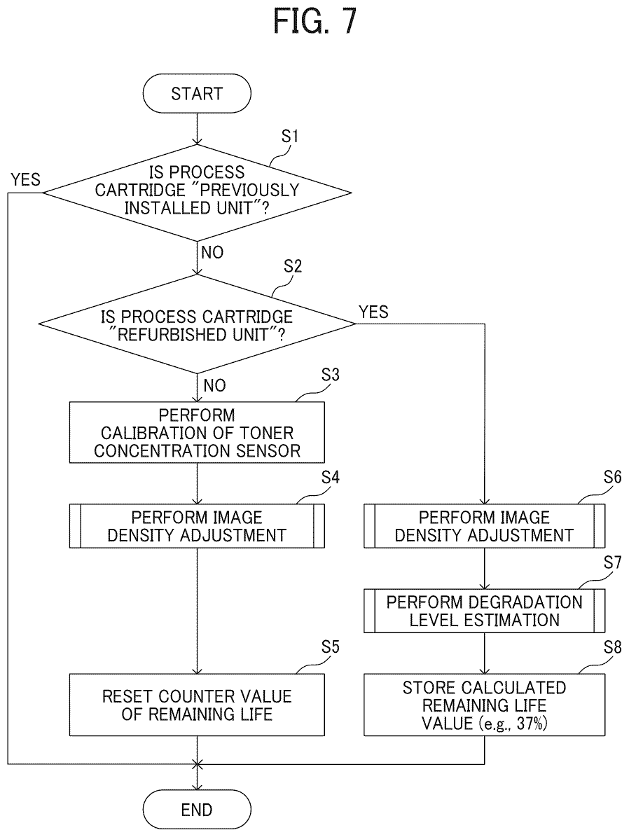

FIG. 7 is a flowchart of the initial setup and adjustment operation, performed by the CPU 80a, when a refurbished process cartridge is installed in the case where the charging unit 62 is replaced together with the process cartridge. The refurbished process cartridge is a process cartridge including a refurbished charging unit.

When the process cartridge installed (mounted) in the apparatus body 10 is a previously installed unit (YES in step S1), nothing is done, and the process is ended.

By contrast, when the process cartridge installed (mounted) in the apparatus body 10 is an unused unit (NO in step S1, NO in step S2), the sensor calibration is carried out in step S3. The sensor calibration is a process for adjusting (calibrating) the output level of the toner concentration sensor 56. In particular, the output of the toner concentration sensor 56 is checked at a toner concentration of 7 wt % of the initial developer, and the voltage to be applied is adjusted such that the output of the toner concentration sensor 56 reaches a predetermined reference output. The adjusted voltage value is stored in the EEPROM of the toner concentration sensor 56.

In a case where the charging unit 62 is replaced together with the photoconductor unit 60 or the charging unit 62 is replaced alone, the sensor calibration is not necessary.

In step S4, the CPU 80a performs image density adjustment when the sensor calibration is completed. When image density adjustment is performed, first, a gradation pattern including multiple toner patches having different image densities is formed on the intermediate transfer belt 32a by varying the developing potential. The developing potential is defined as the difference between a developing bias and an exposure potential on the surface of the photoconductor drum. Then, the optical sensor unit 63 detects a toner adhesion amount (mg/cm²) of each toner patch of the gradation pattern on the intermediate transfer belt 32a.

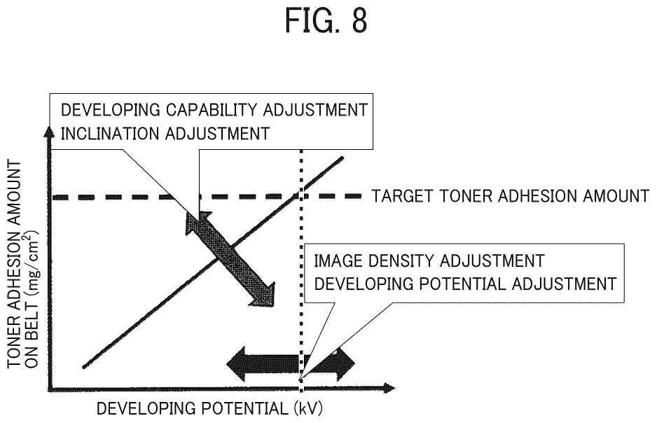

Then, the relation between the detected toner adhesion amount of each toner patch and the developing potential is linearly approximated to calculate a relational expression represented by “y=ax+b,” as illustrated in FIG. 8. The least squares method can be used for linear approximation, but the method is not limited thereto. Then, the CPU 80a checks whether the developing capability, i.e., developing gamma (γ), which is the inclination of the linear function (y=ax+b) indicating the relation between the calculated toner adhesion amount and the developing potential, is within a target range. If the developing capability, i.e., developing gamma, is higher than the target range, abnormal images such as toner scattering and background fouling may occur, whereas if it is lower than the target range, abnormal images such as carrier adhesion (white spots) may occur. Accordingly, when the calculated developing capability (developing gamma) is not the target value, toner is supplied into the developing unit, or the toner is consumed to adjust the developing capability (developing gamma). For example, the target range is 1.00±0.10 ([mg/cm²]/kV).

Specifically, when the calculated developing capability is higher than the target range, a target voltage value Vtref of the toner concentration sensor is lowered. Then, the toner of the developer in the developing unit is consumed by forming the pattern image for consumption to adjust the toner content of the developer to the changed target value. By contrast, when the calculated developing capability is lower than the target range, the target voltage Vtref of the toner concentration sensor for the developer to be controlled is increased. Then, the toner is supplied to the developing unit, to adjust the toner content of the developer to the changed target value.

Then, image density adjustment is performed to adjust the image forming conditions (developing bias, charging bias, and exposure) to obtain a target image density. Specifically, the developing potential to calculate a predetermined target adhesion amount is determined based on the relation between the calculated toner adhesion amount and the developing potential illustrated in FIG. 8. When the developing capability is adjusted, the gradation pattern is formed again after the adjustment. Then, the relation between the toner adhesion amount and the developing potential is calculated again.

The CPU 80a calculates the developing bias based on the developing potential thus determined. The CPU 80a further determines a charging bias based on the calculated developing bias and a predetermined background potential. The background potential is the difference (150 V in the present embodiment) between the potential of a background portion (unexposed portion) of the surface of the photoconductor and the developing bias potential. When the image density adjustment is completed, the CPU 80a resets the cumulative number of printed sheets, stored in the storage device 81, to “0” in step S5. The cumulative number of printed sheets is used for the service life determination. That is, the remaining service life is set to 100%.

By contrast, when the process cartridge installed (mounted) in the apparatus body 10 is a refurbished unit (NO in S1, YES in S2), in step S6, the CPU 80a performs the image density adjustment without performing the above-described sensor calibration. In the case of a refurbished unit, the sensor calibration has already been performed in the apparatus in which the process cartridge was used prior to reuse, and the EEPROM of the toner concentration sensor 56 stores a voltage value to be applied to the magnetic material detection circuit. Accordingly, the sensor calibration described above is not performed. In the case of a refurbished unit, the toner concentration is not necessarily 7 wt % because the developing unit is filled with the previously used magnetic carrier and then filled with a predetermined amount of toner. Accordingly, when the sensor calibration is performed, the calibration may cause a detection deviation.

The CPU 80a performs image density adjustment similar to that performed for an unused unit, and adjusts the developing capability and the image forming conditions, such as the developing bias. When the adjustment of the image forming condition is completed, in step S7, the CPU 80a performs degradation level estimation in which the degradation level of the “refurbished” charging unit installed in the refurbished process cartridge is estimated.

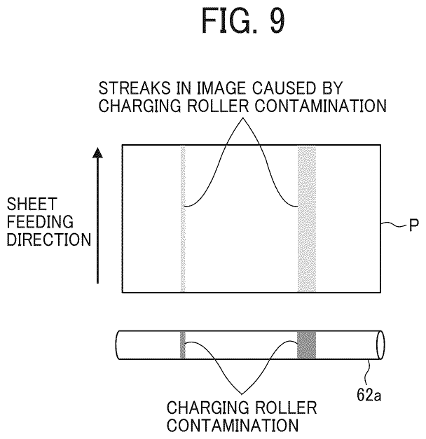

FIG. 9 is a diagram illustrating an abnormal image due to the degradation of the charging unit 62 (contamination of the charging roller 62a).

As illustrated in FIG. 9, when the charging roller 62a is contaminated, the electric resistance value of the contaminated portion changes, the charging function of the contaminated portion deteriorates, and the surface of the photoconductor opposite the contaminated portion is insufficiently charged. When the developing device electrostatically moves the toner to the surface of the photoconductor to develop the latent image thereon, the toner also moves electrostatically to the insufficiently charged portion on the surface of the photoconductor. As a result, a streaked image (streak image) is generated as illustrated in FIG. 9.

As the charging roller 62a becomes more heavily contaminated, the density of the streak image increases, and the number and the thickness of the streak images increase. Accordingly, the degradation level of the charging roller 62a is estimated from the density of the streak images and the ratio of the streak images occupying the image. Then, the remaining service life of the charging unit 62 is estimated.

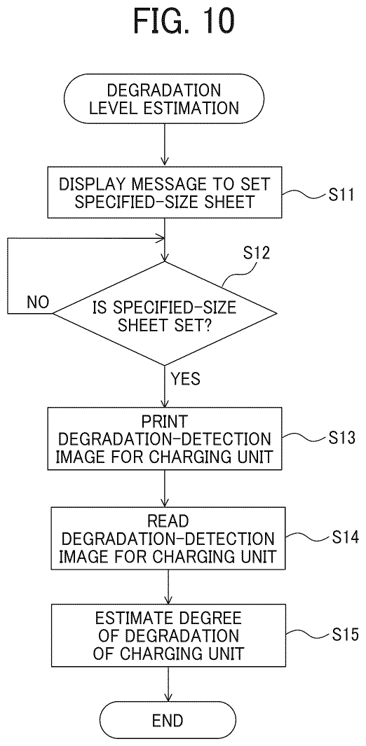

FIG. 10 is a flowchart of a degradation level estimation process, performed by the CPU 80a (the life setting control unit 85).

In step S11, the CPU 80a displays, on the control panel 65 (see FIG. 3), a message prompting the user to set a sheet of specified size on the bypass feeding tray 44. The specified size is such that the length of a sheet in a main-scanning direction (sheet width size) is equal to or greater than the length, in the main scanning direction (axial direction), of a charging region in which the charging roller 62a charges the surface of a photoconductor drum, and the length of the sheet in the sub-scanning direction is equal to or greater than the circumferential length of the charging roller 62a. The width size of the sheet to be set may be changed to a width size that is most frequently used by the user.

Further, the sheet to be set may be a specified sheet packed in a packing box together with the “refurbished” process cartridge. As a result, the brand of the paper type is fixed, and the image density of the paper itself is fixed, allowing the subsequent control to be accurately performed.

When it is detected that the sheet of specified size is set (YES in S12), in step S13, the CPU 80a controls the color copier 1 to print the degradation detection image for detecting the degradation of the charging unit, for the color of the installed “refurbished” process cartridge. In the degradation detection image, streak images are visible. For example, when the operator sets a sheet of the specified size on the sheet feeding tray or the bypass feeding tray and then presses a “setting completion button” displayed on the control panel 65, it is detected that the sheet of the specified size has been set.

The charging unit degradation detection image can be obtained by performing blank-sheet printing under the image forming conditions that increase sensitivity to streak images, which worsen in accordance with the level of degradation (contamination) of the charging unit 62 (the charging roller 62a).

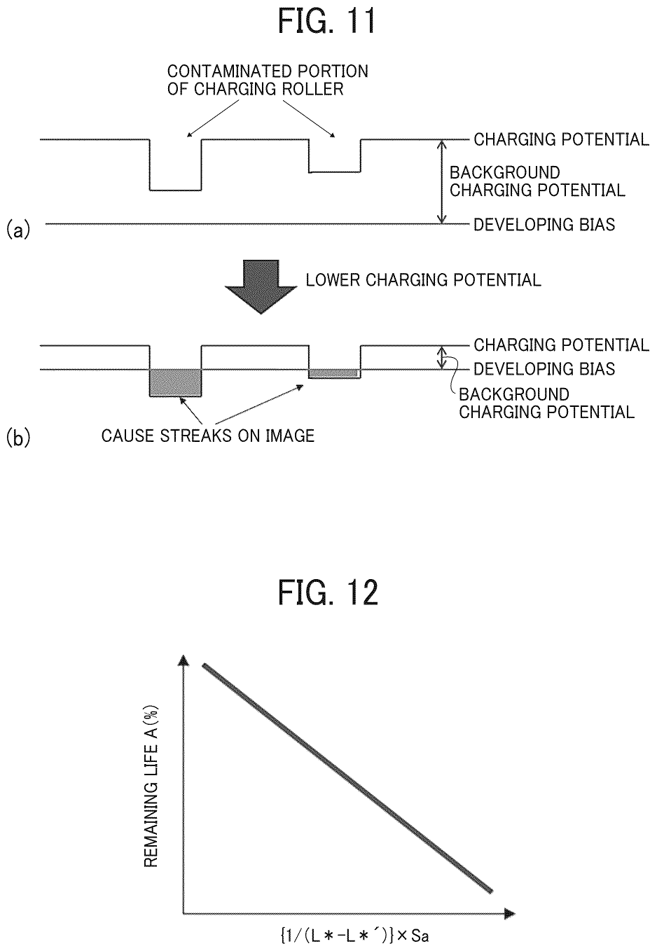

In FIG. 11, (a) illustrates a background potential (the difference between the potential of a background portion (unexposed portion) of the surface of the photoconductor and the developing bias potential) for normal printing. FIG. 11, (b) illustrates the background potential when the charging unit degradation detection image is printed.

In the background potential for normal printing illustrated in (a) of FIG. 11, although insufficient charging occurs at a portion of the photoconductor drum 7, opposite the contaminated portion of the charging roller 62a, the toner does not adhere to the insufficiently charged portion.

By contrast, at the time of printing the charging unit degradation detection image, as illustrated in (b) of FIG. 11, at least one of the developing bias and the charging bias is changed to make the background potential lower than that at the time of normal printing. As a result, the toner electrostatically adheres to the insufficiently charged portion of the photoconductor drum 7, so that a streak image due to the degradation of the charging unit 62 (contamination of the charging roller 62a) is liable to appear. In (b) of FIG. 11, in the left one of the two insufficiently charged portions, the contamination of the charging roller 62a is severe, and the level of the defective charging is severe. Thus, a large amount of toner adheres, and the image density of the streak image is thicker in the insufficiently charged portion on the left.

As described above, the charging unit degradation detection image is printed under the image forming condition in which the background potential is lower than that in the normal printing, so that the streak image, which worsens with the level of degradation (contamination) of the charging unit 62 (the charging roller 62a), can be more sensitive. As a result, the streak image is formed on the sheet.

Specifically, at least one of the developing bias and the charging bias is changed from the value adjusted by the image density adjustment described above to lower the background potential by 50 V from the background potential (150 V) for normal printing, and exposure is turned off to print the charging unit degradation detection image. Primary transfer conditions and secondary transfer conditions are the same as those for normal printing. The background potential set when printing the charging unit degradation detection image is merely an example, and may be different depending on the machine.

When multiple “refurbished” process cartridges (charging units 62) are installed in replacement at the same time, the background potential is changed for each color one by one, and a blank image is printed on a sheet. For example, when a cyan (C) process cartridge and a magenta (M) process cartridge are replaced with “refurbished” process cartridges (charging units 62) at the same time, the background potential for cyan is first changed, and blank-sheet printing is performed. After the printing, the background potential for cyan is returned to the predetermined background potential (150 V) for normal printing, and then the background potential for magenta is changed to perform blank-sheet printing.

In step S14, the in-line sensor 64 serving as an image reading sensor, disposed upstream from the ejection roller pair 5b, reads the charging unit degradation detection image (streak image) formed on the sheet by the blank-sheet printing with the lowered background potential in this manner. Alternatively, the sheet that bears the charging unit degradation detection image and is ejected to the output tray 5a may be set in the image reading device 2 to be read by the image reading device 2. However, reading the charging unit degradation detection image, with the in-line sensor 64 disposed in the sheet ejection path of the color copier 1, before the sheet is ejected to the output tray 5a can prevent inconveniences such as substitution of the read image.

This is preferable because the degradation level of the installed “refurbished” process cartridge (charging unit) can be accurately ascertained.

Alternatively, an optional unit including the in-line sensor 64 may be included in the in-machine ejection unit 5 to read a background-fouling detection image and a white-spot detection image. Alternatively, the charging unit degradation detection image (streak image) printed on the sheet may be captured by, for example, a smartphone, and the captured charging unit degradation detection image (streak image) may be transmitted to the color copier 1 by any desired transmission means, such as e-mail or an application. This provides an advantage that, even in an inexpensive image forming apparatus that does not include the in-line sensor 64 or the image reading device 2, the degradation level of the charging unit 62 can be estimated based on the charging unit degradation detection image.

In step S15, based on read image data (reading result) obtained by reading the sheet bearing the charging unit degradation detection image (streak image), a degradation level of the “refurbished” charging unit installed in the replacement is estimated, and a remaining service life is estimated.

First, from the read image data, a lightness (L*) of the charging unit degradation detection image (streak image), a lightness (L*′) of the sheet bearing the charging unit degradation detection image, and a streak area Sa, which is an area of the charging unit degradation detection image (streak image), are obtained.

When the charging unit degradation detection image is formed on a specified sheet that is packed together with the packaged “refurbished” process cartridge (charging unit 62), the lightness (L*′) of the specified sheet is stored in a non-volatile memory, such as the ROM 80b or the storage device 81. When calculating the remaining service life A, the lightness (L*′) of the sheet may be read from the non-volatile memory. Alternatively, the lightness (L*′) of the sheet may be obtained in advance by reading the sheet before printing the charging unit degradation detection image.

Depending on the color, it may be difficult to detect the lightness (L*) of the charging unit degradation detection image (streak image). For a color for which detection of the lightness (L*) of the charging unit degradation detection image is difficult, the read image data may be binarized into monochrome, and only the streak area Sa may be obtained.

The remaining service life A of the charging unit 62 is calculated using the following Equation 1.

Remaining service life A (%)={α/(L*−L*′)}×Sa+100 . . . Equation 1

FIG. 12 is a graph of a relation between the remaining service life A and {1/(L*−L*′)}×Sa.

As described above, as the contamination of the charging roller 62a decreases and the degree of degradation progression of the charging roller is slows, the image density decreases, and the lightness (L*) of the charging unit degradation detection image (streak image) becomes closer to the lightness (L*′) of the sheet. In view of this, a reciprocal value is used for the lightness. A parameter α represents the absolute value of a slope illustrated in FIG. 12.

Equation 1 described above is stored in a non-volatile memory, such as the ROM 80b or the storage device 81 of the color copier 1. The remaining service life A (%) of the charging unit is calculated from the lightness (L*) of the charging unit degradation detection image (streak image), the lightness (L*′) of the sheet, the streak area Sa, and Equation 1 stored in the non-volatile memory. The parameter α of Equation 1 may be set for each of Y, M, C, and K, and stored in the ROM 80b or the storage device 81 of the controller 80.

In this description, the remaining service life represents the level of degradation relative to an “unused” charging unit 62. The remaining life of 100% corresponds to a degradation level equivalent to that of an unused charging unit 62. That is, the remaining life of 100% corresponds to an undeteriorated state and the degradation level of 0%. The remaining life of 0% corresponds to a degradation level equivalent to that of the unused charging unit 62 that has been used up to the lifetime number of printed sheets. That is, the remaining life of 0% corresponds to the degradation level of 100%)

After the remaining service life of the charging unit 62 is calculated in this manner, the degradation level estimation process is ended. After the degradation level estimation process is ended, as illustrated in FIG. 7, in step S8, the service life of the “refurbished” charging unit 62 installed and the set service life of the charging unit 62 are stored in the ROM 80b or the storage device 81 as the life (remaining service life) of the process cartridge. In a configuration in which the charging unit 62 is replaced together with the photoconductor unit 60, the set life of the charging unit 62 is stored in the ROM 80b or the storage device 81 as the life (remaining service life) of the photoconductor unit 60. In a configuration in which the charging unit 62 is replaced alone, the set life of the charging unit is stored in the ROM 80b or the storage device 81 as the life (remaining service life) of the charging unit.

For example, when the calculated remaining service life is 37%, a value corresponding to 37% of the end-of-life print count, preliminarily stored in the ROM 80 b or the storage device 81, set when an “unused” charging unit 62 is installed, is set as the end-of-life print count. After the end-of-life print count is stored in the ROM 80b or the storage device 81, the cumulative number of printed sheets is reset. Alternatively, a value corresponding to 63% (100%−37%) of the end-of-life print count may be set as the cumulative number of printed sheets, and a count value of the cumulative number of printed sheets stored in the storage device 81 or the ROM 80b may be updated.

In this manner, when the charging unit 62 is replaced with a “refurbished” charging unit, the remaining service life of the charging unit 62 is set based on the degradation level of the charging unit 62 (a contamination state of the charging roller 62a). Accordingly, the service life can be appropriately determined for the “refurbished” charging unit 62, and the generation of abnormal images can be reduced.

Further, at a time when the charging unit 62 is replaced with a “refurbished” charging unit (when the refurbished charging unit 62 is installed for the first time), the degradation level of the charging unit 62 is grasped, and the life is set. Accordingly, also for a “refurbished” charging unit 62, service life can be managed based on the cumulative number of printed sheets and the end-of-life print count, similar to an “unused” charging unit 62. Accordingly, also for a “refurbished” charging unit 62, when the remaining number of days calculated from an average daily print count and the difference between the set end-of-life print count and the cumulative number of printed sheets falls below a threshold, it can be determined that the charging unit 62 is close to the end of its life. As a result, also for a “refurbished” charging unit 62, control operations, such as displaying a message indicating that the charging unit 62 is close to the end of its life on the control panel 65 or notifying the service center that there is a charging unit 62 whose life is close to the end, can be performed.

In a configuration in which the charging unit 62 is replaced together with a process cartridge, when the life of the charging unit 62 expires, the process cartridge is replaced. In a configuration in which the charging unit 62 is replaced together with the photoconductor unit 60, when the life of the charging unit 62 expires, the photoconductor unit 60 is replaced. In a configuration in which the charging unit 62 is replaceable alone, only the charging unit 62 is replaced.

In the description above, Equation 1 for calculating the remaining service life is stored in a memory (the storage device 81 or the ROM 80b) of the color copier 1. However, Equation 1 may be stored in the EEPROM 121 of the IC chip 115. This is advantageous, for example, when a functional upgrade of the charging unit 62 is introduced after mass production, and both a charging unit 62 before the functional upgrade and a charging unit 62 after the functional upgrade become “refurbished” units. For example, the parameter α of Equation 1 suitable for calculating the remaining service life of the charging unit 62 before the functional upgrade may differ from the parameter α of Equation 1 suitable for calculating the remaining service life of the charging unit 62 after the functional upgrade. Accordingly, by storing Equation 1 in the IC chip 115 of the charging unit 62, a highly accurate life setting can be performed for each of a refurbished charging unit before the functional upgrade and a refurbished charging unit after the functional upgrade.

Preferably, the end-of-life print count that is set when an “unused” charging unit 62 is installed is stored in the IC chip 115 of the charging unit 62. Accordingly, when an “unused” charging unit 62 having upgraded functionality is installed, the end-of-life print count can be set to an optimal value.

Alternatively, an operator may visually detect the charging unit degradation detection image (streak image) formed on the sheet, and input detection results via the control panel 65. Such a configuration according to a modification will be described below.

Also in the modification, similarly to the above-described embodiments, when it is detected that the charging unit 62 installed in the apparatus body 10 is a “refurbished” unit, a degradation level estimation process is executed. Then, blank-sheet printing is performed with the background potential lowered, thereby forming a charging unit degradation detection image (streak image) on a sheet.

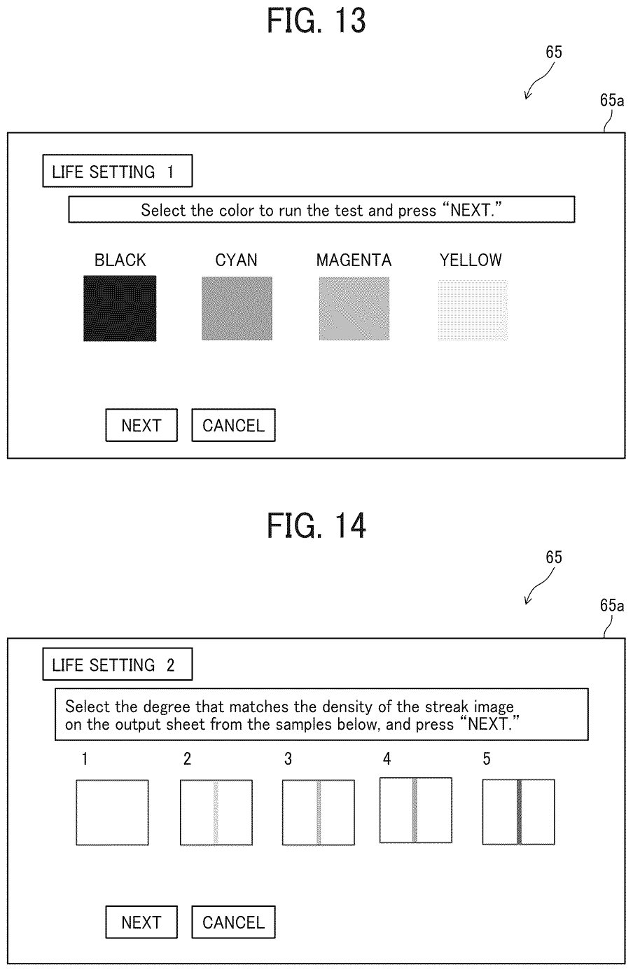

Subsequently, the operator operates the control panel 65 to display a “Life Setting 1” screen, as illustrated in FIG. 13.

Alternatively, after the charging unit degradation detection image is printed, a unit replacement setting screen may be displayed on a display portion 65a of the control panel 65.

On the “Life Setting 1” screen illustrated in FIG. 13, selection icons for Y, M, C, and K are displayed.

After selecting the selection icon corresponding to the color of the installed “refurbished” charging unit, the operator presses a “Next” button, whereby a “Life Setting 2” screen illustrated in FIG. 14 is displayed on the display portion 65a.

As illustrated in FIG. 14, on the “Life Setting 2” screen, multiple image density rank selection icons are displayed. Each image density rank selection icon includes a numeral indicating the image density rank of the charging unit degradation detection image (streak image) and a sample image corresponding to the image density rank. In the present modification, the image density is divided into five levels, and five image density rank selection icons are displayed on the “Life Setting 2” screen. Although the five image density ranks are used in the present modification, the number of image density ranks is not limited thereto, and is appropriately set in consideration of accuracy for life setting and ease of visual determination.

For each image density rank, a corresponding sample image may be printable on a sheet or may be displayed in an enlarged manner. This makes it easier for the operator to compare the image density of the charging unit degradation detection image (streak image) printed on the sheet with that of the sample images corresponding to the respective image density ranks.

The operator compares the sample images of the respective image density ranks displayed on the “Life Setting 2” screen with the image density of the charging unit degradation detection image (streak image) printed on the sheet, and selects an image density rank selection icon having the closest image density. When the operator selects the icon and presses a “Next” button, the input of the image density rank is received.

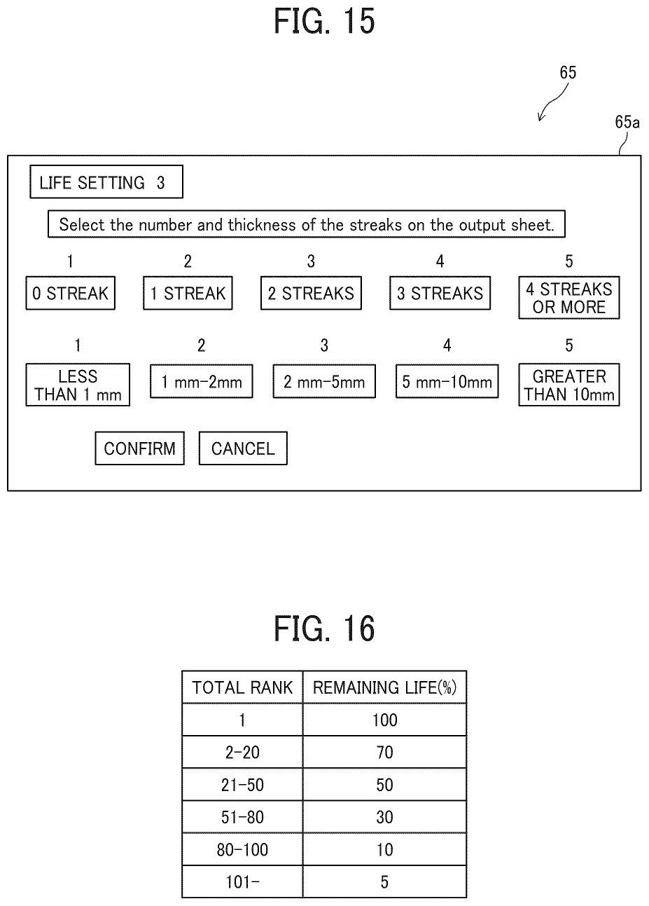

When the “Next” button displayed on the “Life Setting 2” screen is pressed, a “Life Setting 3” screen illustrated in FIG. 15 is displayed on the display portion 65a. The CPU 80a causes those screens to be displayed on the display portion 65a via the control panel control unit 84. On the “Life Setting 3” screen, multiple streak number rank selection icons are displayed. Each streak number rank selection icon includes a numeral indicating a streak number rank and a corresponding range of the number of streaks.

Multiple streak thickness rank selection icons are displayed below the multiple streak number rank selection icons. Each streak thickness rank selection icon includes a streak thickness rank and a range of thicknesses corresponding to the streak thickness rank. In the present modification, both the streak number rank and the streak thickness rank are five ranks, but the number of the ranks is not limited thereto.

The operator selects a streak number rank selection icon corresponding to the number of streaks on the sheet, measures the thickness of the thickest of the multiple streaks using a scale, and selects a corresponding streak thickness rank selection icon. After selecting the streak number rank selection icon and the streak thickness rank selection icon, the operator presses a “Confirm” button. When the “Confirm” button is pressed, the streak number rank and the streak thickness rank are received, and the image density rank selected on the “Life Setting 2” screen, and the streak number rank and the streak thickness rank selected on the “Life Setting 3” screen are finalized.

After the image density rank, the streak number rank, and the streak thickness rank are finalized, the remaining service life of the installed “refurbished” charging unit 62 is set based on the finalized image density rank, the streak number rank, and the streak thickness rank.

The ROM 80b or the storage device 81 of the controller 80 stores a data table, illustrated in FIG. 16, in which the remaining service life is associated with a total rank calculated by multiplying the image density rank, the streak number rank, and the streak thickness rank. After the image density rank, the streak number rank, and the streak thickness rank are finalized, these ranks are multiplied to calculate the total rank. At this time, the image density rank, the streak number rank, and the streak thickness rank may be multiplied by predetermined coefficients, respectively, to weigh the ranks. In the above description, the total rank is calculated by multiplying the image density rank, the streak number rank, and the streak thickness rank. However, the calculation of the total rank is not limited thereto, and the total rank may be calculated by adding these ranks.

After the total rank is calculated in this manner, the remaining service life of the installed “refurbished” charging unit is determined based on the calculated total rank and the data table illustrated in FIG. 16. After that, similarly to the above-described embodiments, the end-of-life print count is calculated based on the determined remaining service life and the end-of-life print count. The end-of-life print count, which is set when an “unused” charging unit 62 is installed, is stored in advance in the ROM 80b or the storage device 81. Then, the calculated end-of-life print count is stored in the ROM 80b or the storage device 81 as the service life of the charging unit 62. In the configuration in which the charging unit 62 is replaced together with a process cartridge, the calculated end-of-life print count is stored in the ROM 80b or the storage device 81 as the service life of the process cartridge. In the configuration in which the charging unit 62 is replaced together with the photoconductor unit 60, the remaining service life corresponding to the calculated end-of-life print count is stored in the ROM 80b or the storage device 81 as the service life of the photoconductor unit 60. After the end-of-life print count is stored, the cumulative number of printed sheets is reset to 0.

Alternatively, a value calculated by multiplying (100%−the determined remaining service life %) by the end-of-life print count set when an “unused” charging unit is installed may be used, to update the count value of the cumulative number of printed sheets.

When multiple “refurbished” charging units are installed at the same time and there is a charging unit for which the end-of-life print count has not been set (or a count value has not been updated), the “Life Setting 1” screen illustrated in FIG. 13 is displayed again on the display portion 65a after setting the end-of-life print count. This operation allows the apparatus to prompt the operator to input information for a charging unit degradation detection image (streak image) of the color for which input has not yet been performed.

Also in the present modification, similarly to the above-described embodiments, when the charging unit 62 is replaced with a “refurbished” charging unit, the remaining service life of the charging unit 62 is set based on the degradation level of the charging unit 62 (the contamination state of the charging roller 62a). Accordingly, the service life can be appropriately determined for the “refurbished” charging unit 62, and the generation of abnormal images can be reduced.

Further, even in an image forming apparatus that does not include the in-line sensor 64 or the image reading device 2, the degradation level of the installed “refurbished” charging unit 62 can be grasped based on a streak image that worsens in accordance with the degradation progression of the charging unit 62. Accordingly, a highly accurate life setting can be performed with an inexpensive configuration.

In the above description, the service life of the charging unit 62 is determined based on the cumulative number of printed sheets after replacement of the charging unit 62. However, the service life of the charging unit 62 may be determined based on, for example, the cumulative driving time of the charging unit 62.

Further, the remaining service life may be obtained by reading the charging unit degradation detection image using the in-line sensor described above, and the remaining service life may also be determined by allowing the operator to input the state of the charging unit degradation detection image via the control panel 65 as described in the above-described modification. In this case, the shorter of the remaining service life obtained by reading the charging unit degradation detection image and the remaining service life determined based on the state input by the operator is set as the remaining service life of the “refurbished” charging unit.

The CPU 80a (the life setting control unit 85) may compare the remaining life determined based on an input of the level of the charging unit degradation detection image by an operator with the remaining life obtained by reading the charging unit degradation detection image, and may determine whether the rank selected by the operator is correct. For example, when the remaining service life determined based on the operator's input differs from the remaining service life obtained by reading the charging unit degradation detection image by a threshold or more, the CPU 80a (the life setting control unit 85) may determine that the rank selected by the operator is erroneous. When determining that the rank selected by the operator is erroneous, the CPU 80a causes a message indicating the possibility of an error in the selected rank to be displayed on the display portion 65a of the control panel 65, and an inquiry is made as to whether reselection is to be performed.

The above-described embodiments are illustrative and do not limit the embodiments of the present disclosure. Thus, numerous additional modifications and variations are possible in light of the above teachings. For example, elements and/or features of different illustrative embodiments may be combined with each other and/or substituted for each other within the scope of the present disclosure. For example, although the transfer unit 32 is an intermediate transfer unit including an intermediate transferor in the above description, a direct transfer unit that directly transfers an image from a photoconductor onto a sheet may be employed.

The configurations described above are examples, and various aspects of the present disclosure provide, for example, the following effects, respectively.

### Aspect 1

An image forming apparatus includes a latent image bearer such as the photoconductor drum 7, the charging unit 62 that includes a charger such as the charging roller 62a disposed opposite a surface of the latent image bearer and that uniformly charges the surface of the latent image bearer, an exposure device such as the writing unit 34 that exposes the uniformly charged surface of the latent image bearer to form an electrostatic latent image, a developing device such as the developing unit 30 that develops the electrostatic latent image on the latent image bearer into a toner image with a developer, a transfer device such as the transfer unit 32 that transfers the toner image from the latent image bearer onto a sheet such as a paper sheet directly or indirectly via an intermediate transferor, and circuitry such as the 80 that determines a service life of the charging unit 62. In the image forming apparatus, the charging unit 62 is installable to and detachable from an apparatus body 10. The controller 80 detects whether an installed charging unit 62 is a refurbished unit. When the controller 80 detects that the installed charging unit 62 is a refurbished unit, the controller 80 forms a degradation level detection image, such as a charging unit degradation detection image, for grasping a degradation level of the installed refurbished charging unit 62, and sets the remaining service life of the installed refurbished charging unit 62 based on the degradation level detection image.

Substances, such as toner and a lubricant, that are not removed by the photoconductor cleaning blade 61a gradually solidify on the charger such as the charging roller 62a of the charging unit 62, which is disposed opposite the surface of the latent image bearer, due to use over time, and the surface of the charging roller 62a is gradually contaminated. The contamination adhering to the charger due to use over time changes the electric resistance value of the charger, and the charger deteriorates.

When the charger deteriorates, an abnormal image due to defective charging, such as insufficient charging, occurs when the surface of the latent image bearer, such as the photoconductor drum 7, is charged, and the charging unit 62 thereby reaches the end of its life. Specifically, a background potential (the difference between the surface potential of an unexposed portion of the latent image bearer and the surface potential of the developing roller) decreases at the portion of the surface of the latent image bearer where insufficient charging occurs, toner adheres to that portion, and a streak image is generated as an abnormal image.

When the charging unit 62 is recycled as a refurbished unit, the contamination on the surface of the charger is cleaned. However, in some cases, a charging unit having the charger on which contamination remains is installed in the image forming apparatus as a refurbished unit because, for example, contamination stuck to the surface of the charger due to use over time is not completely removed. Then, the service life of the refurbished charging unit differs depending on the level of contamination on the surface of the charger. Then, the service life is not appropriately determined for the refurbished charging unit.

According to Aspect 1, when the controller detects that the installed charging unit is a refurbished unit, the controller forms a degradation level detection image for grasping the degradation level of the refurbished charging unit. The degradation level (contamination state) of the charger can be grasped by forming the degradation level detection image under a specific image forming condition that is likely to cause a streak image. A streak image is an abnormal image due to a defective charging, such as insufficient charging. The specific image forming condition is, for example, a condition in which the background potential is made smaller than that for normal printing. In this manner, because the degradation level of the charger can be grasped based on the degradation level detection image, the remaining service life of the refurbished charging unit can be appropriately set. Then, the service life of the refurbished charging unit can be appropriately determined.

### Aspect 2

The image forming apparatus according to Aspect 1 further includes an image reading sensor, such as an in-line sensor 64, that reads an image printed on a sheet, such as a paper sheet. The controller 80 prints a degradation level detection image, such as the charging unit degradation detection image, on a sheet, reads the degradation level detection image printed on the sheet using the image reading sensor, and sets the remaining service life of the installed refurbished charging unit 62 based on a reading result of the degradation level detection image by the image reading sensor.

Accordingly, as described above, the remaining service life of the replaced refurbished charging unit can be set based on the degradation level detection image read by the image reading sensor, and an operator's burden can be reduced as compared with a configuration in which an operator inputs the remaining service life of the replaced refurbished charging unit based on the degradation level detection image formed on the sheet.

### Aspect 3

The image forming apparatus according to Aspect 1 or 2 further includes an input device, such as the control panel 65, to input information. The controller 80 prints a degradation level detection image, such as the charging unit degradation detection image, on a sheet, such as a paper sheet. When the input device receives an input of information on the state of the degradation level detection image printed on the sheet, the controller 80 sets the remaining life of the installed refurbished charging unit based on the input information on the image state.

According to this configuration, as in the above-described modification, even in an image forming apparatus that does not include an image reading sensor, such as the in-line sensor 64, to read an image printed on a sheet, such as a paper sheet, the remaining life of the refurbished charging unit 62 that has been installed can be set based on the degradation level detection image. Thus, the service life of the refurbished charging unit can be set with high accuracy with an inexpensive configuration.

### Aspect 4

In any one of Aspects 1 to 3, the controller 80 forms the degradation level detection image under an image forming condition different from an image forming condition for normal printing.

This allows, as described above, a degradation level detection image, such as a charging unit degradation detection image, to be formed under a specific print setting that is likely to produce a streak image, which is an abnormal image corresponding to the degradation level of the charging unit 62. The specific print setting increases sensitivity to a streak image that worsens as degradation of the charging unit 62 progresses. Accordingly, the degradation level of the charging unit 62 can be accurately estimated based on the degradation level detection image, and the remaining life can be accurately set.

### Aspect 5

In Aspect 4, the controller 80 sets the background potential to a value (e.g., 50 V) having an absolute value smaller than a value (e.g., 150 V) for normal printing, and forms the degradation level detection image without performing exposure by the exposure device.

This allows, as described above, a degradation level detection image, such as a charging unit degradation detection image, to be formed under a specific print setting that is likely to cause a streak image which is an abnormal image matching the degradation level of the charging unit 62. The specific print setting is a print setting in which sensitivity to a streak image which deteriorates with the progress of degradation of the charging unit 62 is increased. Accordingly, the degradation level of the charging unit 62 can be accurately estimated based on the degradation level detection image, and the remaining life can be accurately set.

### Aspect 6

In any one of Aspects 1 to 5, the charging unit 62 or the detachable unit (the process cartridge or the photoconductor unit 60) including the charging unit 62 and the latent image bearer such as the photoconductor drum 7, detachably installable in the apparatus body, includes a memory, such as the IC chip 115 that stores a history of installation in the apparatus body and information indicating whether the charging unit is a refurbished unit. The controller 80 reads the information from the memory and determines whether the charging unit has been replaced and whether the installed charging unit is a refurbished unit when the charging unit 62 or the detachable unit is installed in the apparatus body.

According to this configuration, as described above, by checking the information stored in the memory, such as the IC chip 115, when the charging unit 62 is installed, the controller 80 can determine whether the charging unit 62 has been replaced and whether the replaced charging unit 62 is a refurbished unit.

### Aspect 7

In Aspect 6, when the controller 80 determines that the charging unit 62 has been replaced, the controller 80 stores the history of installation in the memory, such as the IC chip 115.

According to this configuration, only when the refurbished charging unit 62 is installed for the first time, the setting of the remaining service life can be performed based on the degradation level detection image (the background fog detection image or the white spot detection image).

### Aspect 8

In any one of Aspects 1 to 5, the charging unit 62 or the detachable unit (the process cartridge or the photoconductor unit 60) including the charging unit 62 and the latent image bearer such as the photoconductor drum 7, detachably installable in the apparatus body, includes a first electric circuit, such as the first circuit portion 151 that is switchable from an electrical state (e.g., an energized state) indicating that the charging unit 62 is unused to an electrical state (e.g., an insulated state) indicating that the use of the unit has been started, and a second electric circuit, such as the second circuit portion 152, that is switchable from the electrical state (e.g., the energized state) indicating that the charging unit 62 is refurbished to the electrical state (e.g., the insulated state) indicating that use of the charging unit 62 has been started. The controller 80 determines whether the charging unit 62 has been replaced and whether the replaced charging unit 62 is a refurbished unit based on the electrical states of the first electric circuit and the second electric circuit.

According to this configuration, as described above, when the first electric circuit, such as the first circuit portion 151, is in the electrical state (e.g., the energized state) indicating that the charging unit 62 is unused, it is detected that the charging unit 62 has been replaced with an “unused unit.” Further, when the second electric circuit, such as the second circuit portion 152, is in the electric state (e.g., the energized state) indicating that the charging unit 62 is a refurbished unit, it is detected that the charging unit 62 has been replaced with a “refurbished unit.” Further, when each of the first electric circuit and the second electric circuit is in the electrical state (e.g., the insulated state) indicating that the use of the charging unit 62 has been started, it can be determined that the charging unit 62 has not been replaced.

### Aspect 9

In Aspect 8, when the controller 80 determines that the charging unit 62 has been replaced with an unused charging unit 62, the controller 80 switches the first electric circuit, such as the first circuit portion 151, to the electrical state indicating that use of the charging unit 62 has been started. When the controller 80 determines that the charging unit 62 has been replaced with a refurbished charging unit 62, the controller 80 switches the second electric circuit, such as the second circuit portion 152, to the electrical state indicating that use of the charging unit 62 has been started.

According to this, after the replacement is detected, both the first electric circuit, such as the first circuit portion 151, and the second electric circuit, such as the second circuit portion 152, are switched to the electrical state (the insulated state) indicating that the use has been started.

Accordingly, only when a refurbished charging unit 62 is installed for the first time, the setting of the remaining service life is performed based on the degradation level detection image (the background fog detection image or the white spot detection image).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

1. An image forming apparatus comprising:
a latent image bearer;
a charging unit to uniformly charge a surface of the latent image bearer, the charging unit including a charger disposed opposite the surface of the latent image bearer, the charging unit being detachably installed in the image forming apparatus;
an exposure device to expose the uniformly charged surface of the latent image bearer with light to form an electrostatic latent image;
a developing device to develop the electrostatic latent image on the latent image bearer with a developer into a toner image;
a transfer device to transfer the toner image from the latent image bearer onto a sheet directly or indirectly via an intermediate transferor; and
circuitry configured to:
determine whether the charging unit being installed is a refurbished unit;
when determining that the installed charging unit is the refurbished unit, form a degradation level detection image to grasp a degradation level of the installed refurbished charging; and
set a remaining service life of the installed refurbished charging unit based on the degradation level detection image.

2. The image forming apparatus according to claim 1, further comprising an image reading sensor to read an image formed on the sheet, wherein
the circuitry is configured to:
form the degradation level detection image on the sheet;
read the degradation level detection image on the sheet with the image reading sensor; and
set the remaining service life of the installed refurbished charging unit based on a reading result of the degradation level detection image by the image reading sensor.

3. The image forming apparatus according to claim 1, further comprising an input device to receive input of information, wherein
the circuitry is configured to:
form the degradation level detection image on the sheet; and
when the input device receives input of information on an image state of the degradation level detection image formed on the sheet, set the remaining service life of the installed refurbished charging unit based on the information on the image state.

4. The image forming apparatus according to claim 1, wherein
the circuitry is configured to form the degradation level detection image under an image forming condition different from an image forming condition for normal printing.

5. The image forming apparatus according to claim 4, wherein
the circuitry is configured to:
set a background potential for the degradation level detection image to be smaller in absolute value than a background potential for normal printing; and
form the degradation level detection image without performing exposure by the exposure device.

6. The image forming apparatus according to claim 1, wherein
the charging unit is detachably installed in the image forming apparatus either alone or as a part of a detachable unit including the latent image bearer and the charging unit,
the image forming apparatus further includes a memory that stores a history of installation to the image forming apparatus and information indicating whether the charging unit is a refurbished unit,
the memory is included in either the charging unit or the detachable unit including the latent image bearer and the charging unit, and
when the charging unit is installed in the image forming apparatus, the circuitry is configured to:
read the information from the memory; and
determine whether the charging unit has been replaced, and whether the charging unit being installed is a refurbished unit.

7. The image forming apparatus according to claim 6, wherein
the circuitry is configured to store, in the memory, the history of installation when determining that the charging unit has been replaced.

8. The image forming apparatus according to claim 1, wherein
the charging unit is detachably installed in the image forming apparatus either alone or as a part of a detachable unit including the latent image bearer and the charging unit,
the image forming apparatus further includes:
a first electric circuit configured to be switched from an electric state indicating that the charging unit is unused to an electric state indicating that use of the charging unit has been started; and
a second electric circuit configured to be switched from an electric state indicating that the charging unit is a refurbished unit to an electric state indicating that use of the charging unit has been started,
the first electric circuit and the second electric circuit are included in either the charging unit or the detachable unit including the latent image bearer and the charging unit, and
the circuitry is configured to determine whether the charging unit has been replaced and whether the charging unit being installed is a refurbished unit based on the electric state of the first electric circuit and the electric state of the second electric circuit.

9. The image forming apparatus according to claim 8, wherein
the circuitry is configured to:
switch the first electric circuit to the electrical state indicating that use of the charging unit has been started when determining that the charging unit has been replaced with an unused charging unit; and
switch the second electric circuit to the electrical state indicating that use of the charging unit has been started when determining that the charging unit has been replaced with a refurbished charging unit.
